(19) United States
(12) Patent Application Publication
(10) Pub. No.: US 2011/0051613 A1
(43) Pub. Date: Mar. 3, 2011

(54) METHOD FOR DETECTING THE CENTRAL FREQUENCY OF AT LEAST ONE CARRIER IN A WIDE-BAND DOWNLINK, AND CORRESPONDING COMPUTER SOFTWARE PRODUCT, STORAGE DEVICE AND MOBILE APPARATUS

(75) Inventor: Jean-Pierre Lambert, Grancieres (FR)

(73) Assignee: SIERRA WIRELESS, Issy Les Moulineaux (FR)

(21) Appl. No.: 12/866,849

(22) PCT Filed: Feb. 3, 2009
(86) PCT No.: PCT/EP09/51208

§ 371 Date: Nov. 9, 2010

(30) Foreign Application Priority Data
Feb. 8, 2008 (FR) 0850815

(51) Int. Cl. H04L 12/26

(52) U.S. Cl. 370/252

(57) ABSTRACT

A method is provided for detecting, using a mobile apparatus, the central frequency of at least one carrier of a wide-band downlink of a communication channel associated with a frequency band, wherein the at least one carrier belongs to the frequency band. The method includes a first step of measuring the value of an indicator representative of a power received by the mobile apparatus for a plurality of frequencies evenly spaced in the frequency band in order to obtain a spectrum of values of the indicator on the frequency band. The method includes a second phase of analyzing the spectrum of the indicator, which includes recognizing the shape of the at least one carrier in the indicator spectrum, and detecting the central frequency of the at least one carrier.

### CROSS-REFERENCE TO RELATED APPLICATIONS

This Application is a Section 371 National Stage Application of International Application No. PCT/EP2009/051208, filed Feb. 3, 2009 and published as WO 2009/098204 on Aug. 13, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of mobile apparatuses adapted to communicate in the UMTS (for “Universal Mobile Communication System”) band, and more precisely but not exclusively, that of apparatuses implementing the FDD (for “Frequency Division Duplex”) UMTS technology.

### BACKGROUND OF THE DISCLOSURE

Such as explained by the article “Base stations for mobile telephony (UMTS-FDD) recommendation on the measures”, project of 17 Sep. 2003, published on the Internet site www.environnement-suisse.ch/electrosmog, the UMTS technology is a third generation mobile telephone technology. Each telecommunication operator operates its own UMTS network.

UMTS networks make it possible to transmit data at rates that are clearly higher than the GSM networks. They are as such indicated not only for the vocal traffic but also for the transmission of images or digital videos.

The zone served by a network operator is divided into cells. An emitting antenna supplies one or several cells with UMTS radiation, the latter able to be a part of the same network or of several different networks. In general, several emitting antennas are fixed on a mast or a building constituting as such a base station.

To communicate, the mobile apparatus establishes a radio link with one or several base stations. From the base station, the communication then passes to the radiocommunications management centre by the intermediary of microwave radio links or lines.

The UMTS standard has two operating modes:

the TDD mode (for “Time Division Duplex”): the data transfer on the uplink from the mobile apparatus to the base station is carried out at the same frequency as the data transfer on the downlink from the base station to the mobile apparatus. The sequences implemented on the uplinks and downlinks are separated in time;

the FDD mode (for “Frequency Division Duplex”): the data transfer on the uplink is carried out at the same time as the data transfer on the downlink but the uplinks and downlinks use different frequencies.

A UMTS channel in FDD mode comprises an uplink associated to a carrier frequency of an uplink with a bandwidth of 5 MHz, and a downlink associated to a frequency carrier of a downlink with a bandwidth of 5 MHz.

A UMTS network in FDD mode (comprising FDD cells) can implement a single UMTS channel in FDD mode (i.e. a single pair: uplink frequency/downlink frequency) but it can also implement several UMTS channels in FDD mode (i.e. several pairs: uplink frequency/downlink frequency). All of the emitting antennas of a UMTS network use one of the downlink frequencies of the network and the mobile apparatuses one of the uplink frequencies of the network.

So that several users of mobile apparatuses can transmit data at the same time, the latter is coded, superposed and transmitted simultaneously in the uplink frequency or frequencies of the network. Any mobile apparatus extracts from all of the data emitted only the content that is intended for it.

Conventionally, when a mobile apparatus desires to communicate by means of a UMTS communication channel in FDD mode of a communication network, the apparatus must search for a central frequency of a carrier of a downlink of the UMTS channel (the detection of such a central frequency of a carrier of a downlink makes it possible for it to confirm that it is located in an FDD cell of the UMTS channel).

Within the framework of this search, in a first phase of searching, the mobile apparatus measures the signals that it receives by scanning the entire UMTS frequency band (for example the UMTS band of 60 GHz which extends between 2110 MHz and 2170 MHz) with a step of 200 kHz. Indeed, the central frequency of a carrier of a downlink of a UMTS channel in FDD mode is defined with a step of 200 kHz. At the end of this scanning, the mobile apparatus obtains at least one frequency window wherein is located a carrier of a downlink.

Thus, within the framework of this search, the apparatus must scan approximately 300 different frequencies (more precisely, 277 frequencies due to the fact that the central frequency of a carrier cannot be located on the frequencies at the edge of the UMTS band due to the width of the carrier which is approximately 4 MHz). However, within the framework of the FDD UMTS technology, the apparatus takes approximately 600 ms per scanned frequency, which implies that this phase of searching across the entire UMTS band is very long (300*600 ms=180 s).

An FDD frequency is defined to the nearest 200 kHz, but the spectral power is distributed in an even manner around this frequency on a band of 4 MHz. These 4 MHz of band correspond to 20 candidate central frequencies wherein a cell can be searched. As such, for each bandwidth of 4 MHz, the mobile apparatus scans the entire frequency window with a step of 200 kHz, by trying each frequency one by one until the carrier is effectively found. This step takes a lot of time (600 ms per frequency tried, or 20*600 ms=12 s).

However, it is important that this search for a carrier be carried out as rapidly as is possible in order to offer a UMTS communication to the user as quickly as possible.

### SUMMARY

An aspect of the disclosure relates to using as a base a reading of the spectrum of an indicator of the power received by the mobile apparatus in order to carry out a recognition of the form of at least one carrier on the spectrum thanks to which a detection of the central frequency of the carrier on a limited window can be implemented.

An embodiment of the invention makes it possible to detect, more rapidly than the conventional techniques, the central frequency of at least one carrier of a wide-band downlink of a communication channel, thus allowing the mobile apparatus to rapidly detect the presence of such a channel and so make it possible for the mobile apparatus to rapidly access this channel.

Advantageously, said step of recognising the form of a current carrier comprises a step of identifying at least two consecutive values of the spectrum of the indicator which are greater than a predetermined threshold, said values being representative of the current carrier.

Preferentially, the step of detecting the central frequency of said current carrier comprises the following steps:

determining a limited frequency window from among a plurality of evenly spaced frequencies, by comparing said at least two consecutive values of the spectrum of the indicator which are greater than a predetermined threshold, said limited window comprising said central frequency;

obtaining said central frequency by scanning said limited window.

Thus, once the carrier obtained, the fact of searching the central frequency on a limited window makes it possible to save time in relation to the conventional techniques which implement a search over a wider window (about 20 frequencies in the case of a UMTS carrier in FDD mode) and therefore makes it possible to rapidly detect the presence of a channel and as such rapidly access this channel.

According to an embodiment, at least two central frequencies of at least two carriers are recognised in the step of recognising. The method further comprises a step of classifying carriers in decreasing order of the value of the indicator.

Thus, only the carrier associated to the strongest power received can be retained, which makes it possible to favour the quality of the communications implemented on this carrier.

Preferentially, the communication channel is a UMTS communication channel in FDD mode, each carrier of a wide-band downlink being a carrier of a UMTS downlink in FDD mode.

Advantageously, said frequency series is evenly spaced by a step of 1.8 MHz.

This step value corresponds to a compromise which makes it possible to reduce the number of times that the indicator is measured on the UMTS band (which makes it possible to reduce the time spent by the mobile apparatus in searching for the central frequency or frequencies of the carrier or carriers of the UMTS channel and as such, in the case where the mobile apparatus detects at least one such central frequency, to reduce the access time, by the mobile apparatus, to the UMTS channel) while ensuring that:

on the one hand, each carrier of the UMTS channel (which is available in the cell wherein the mobile apparatus is located) can be recognised; and

on the other hand, the central frequency of each carrier of the UMTS channel (which is available in the cell wherein the mobile apparatus is located) can be detected effectively.

Indeed, such a step makes it possible for at least two measurements of the indicator to be taken for each mid-height window (of 3.84 MHz) of a carrier.

According to an embodiment, said indicator is the RSSI indicator.

An embodiment of the invention further relates to a computer software product which can be downloaded from a communication network and/or recorded on a medium that can be read by a computer and/or that can be executed by a processor, characterised in that it comprises programme code instructions for the execution of the steps of the method of detecting such as described hereinabove, when said programme is executed on a computer.

An embodiment of the invention further relates to a storage means, possibly totally or partially removable, that can be read by a computer, storing a set of instructions that can be executed by said computer in order to implement the method for detecting such as described hereinabove.

An embodiment of the invention further relates to a mobile apparatus according to claim 10.

The advantages of the computer software product, storage means and mobile apparatus are the same as those of the aforementioned method for detecting, no further details are provided.

### BRIEF DESCRIPTION OF THE DRAWINGS

Other characteristics and advantages shall appear more clearly when reading the following description of a preferred embodiment, provided as a simple and non-restricted example, and the annexed drawings, among which:

FIG. 1 shows an example of the context wherein can be implemented the method for detecting according to a particular embodiment;

FIG. 2 shows an example of the spectrum of the intensity (in an arbitrary unit) of a carrier of a downlink of the UMTS channel in FDD mode in FIG. 1;

FIG. 3 shows the main steps of the method for detecting according to the particular embodiment of the invention;

FIG. 4 shows the first step of measuring an RSSI indicator, for a series of frequencies corresponding to a scanning of the UMTS band with a step which is preferentially 1.8 MHz;

FIG. 5 shows the obtaining of the global spectrum of the RSSI indicator on the UMTS band;

FIG. 6 shows the second step of spectral analysis of the global spectrum of the RSSI indicator on the UMTS band;

FIG. 7 shows a simplified diagram of a mobile apparatus in accordance with a particular embodiment of the invention.

### DETAILED DESCRIPTION OF ILLUSTRATIVE EMBODIMENTS

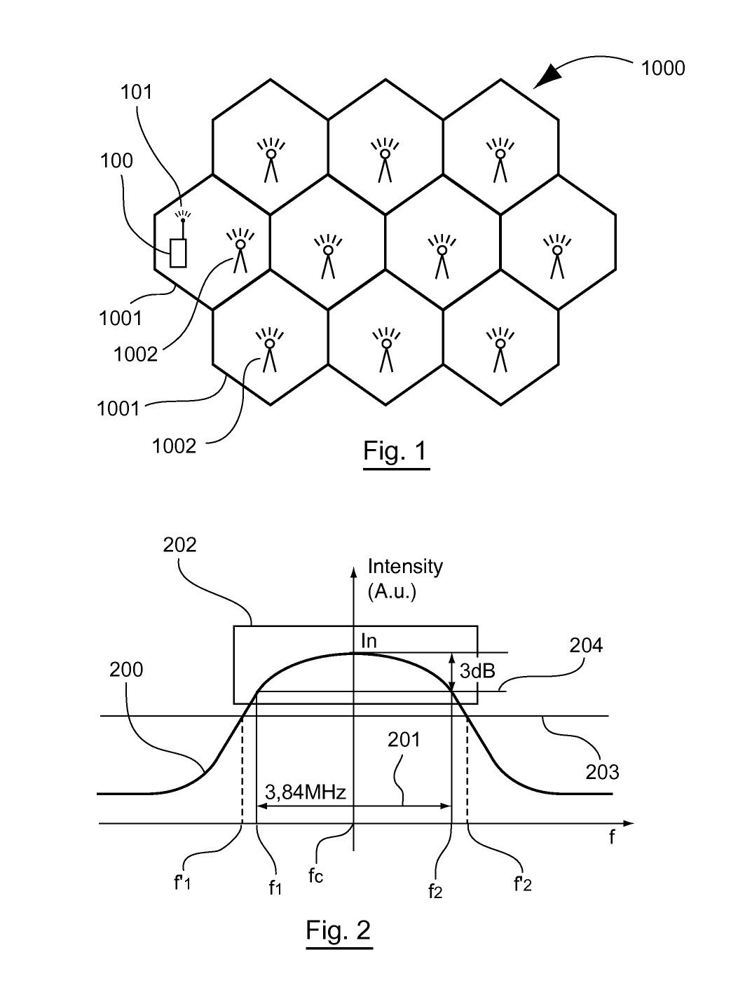

In relation with FIG. 1, an example of the context wherein can be implemented the method for detecting according to a particular embodiment is shown.

A mobile apparatus 100 (for example a portable telephone) comprising an antenna 101 (as well as an adapted reception chain) desires to communicate via a UMTS communication channel in FDD mode (associated to a frequency band hereinafter designated by “UMTS band”) of a communication network 1000. The UMTS communication channel in FDD mode is distributed geographically in the form of cells 1001 and is generated by a network of antennas 1002.

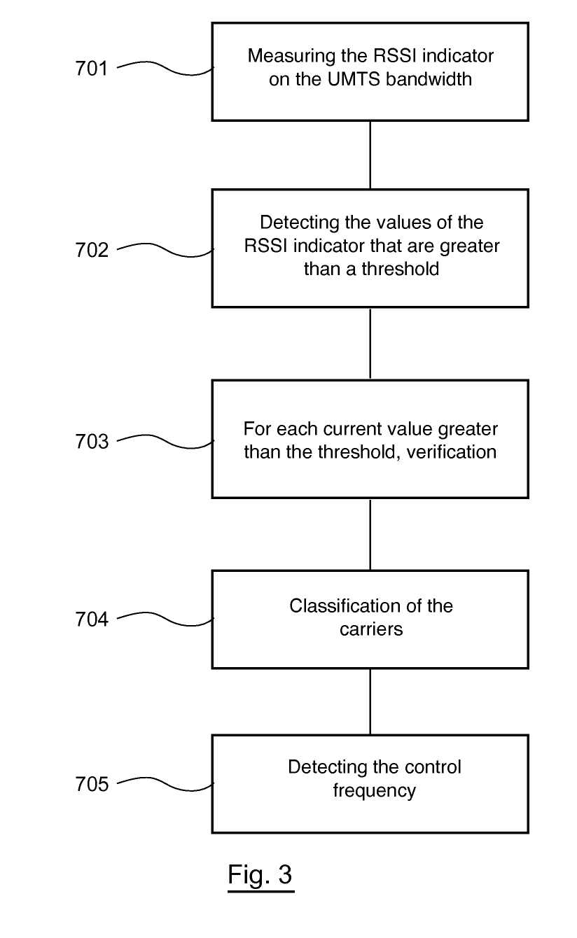

For this, the mobile apparatus implements the method for detecting according to the particular embodiment of the invention (hereinafter described in relation with FIGS. 3 to 6) in order to obtain the central frequency of at least one carrier of a downlink of the UMTS channel which is available in the cell wherein it is located (this carrier belonging to the UMTS band).

For example, the UMTS communication channel in FDD mode is a channel of 60 GHz of bandwidth (hereinafter designated by UMTS band) which extends between 2110 MHz and 2170 MHz (or between 1920 MHz and 1980 MHz) and which comprises three downlink carriers.

Of course, an embodiment of the invention also applies in the case of the detection of at least one central frequency of a carrier of a downlink of a UMTS communication channel in TDD mode (for “Time Division Duplex”).

In relation with FIG. 2, the form of an example of the spectrum of the intensity of a carrier 200 of a downlink of the UMTS channel in FDD mode in FIG. 1 is shown.

This spectrum has a width at mid-height (or at 3 dB) of 3.84 MHz and a maximum value Im of the intensity at the centre of the spectrum in the central frequency Fc of the spectrum. Most of the intensity of the carrier 200 is included in the frequency interval (forming a first segment of frequencies extending between a frequency f1 and a frequency f2 and of which the middle is the central frequency Fc) delimited by the width at mid-height of 3.84 MHz, hereinafter designated by mid-height window 201.

The UMTS standard is such that the mid-height window must be included within a gauge 202 of 5 MHz of spectral bandwidth. As such, most of the energy of the carrier 200 is included in the mid-height window 201 of 3.84 MHz, which itself is included in the gauge 202.

In relation with FIG. 3, the main steps of the method for detecting according to the particular embodiment of the invention is described hereinafter.

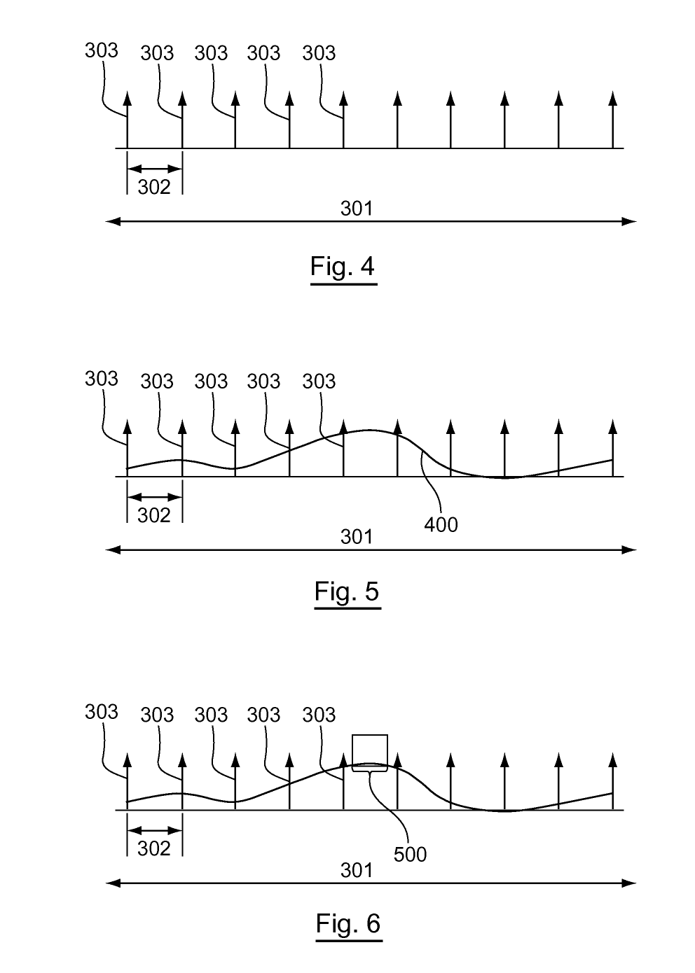

In a first step 701, the mobile apparatus 100 measures an indicator relative to the power received by the mobile apparatus in the cell wherein it is located, for example the RSSI indicator (for “Received Signal Strength Indicator”), for a series of frequencies 303 corresponding to a scanning of the entire UMTS band 301 with a step 302 which is preferentially 1.8 MHz (such as is shown in FIG. 4).

The step 302 is chosen preferentially equal to 1.8 MHz as this corresponds to a compromise which makes it possible to reduce the number of times that the indicator is measured on the UMTS bandwidth 301 (which makes it possible to reduce the time spent by the mobile apparatus in searching the carrier or carriers of the downlink of the UMTS channel and as such, in the case where the mobile apparatus 100 recognises at least one such carrier, to reduce the access time, by the mobile apparatus, to the UMTS channel) while ensuring that:

on the one hand, each carrier of a downlink of the UMTS channel (which is available in the cell wherein the mobile apparatus is located) can be recognised; and

on the other hand, the central frequency Fc of each carrier of a downlink of the UMTS channel (which is available in the cell wherein the mobile apparatus is located) can be detected effectively in the gauge 202 which is associated to the carrier.

Indeed, such a step 302 makes it possible for at least two measurements of the RSSI indicator to be taken for each mid-height window (of 3.84 MHz) of a carrier.

Thus, in terms of the first step 701, the mobile apparatus obtains the values of the RSSI indicator, for the series of frequencies 303 corresponding to a scanning of the entire UMTS bandwidth 301 with the step 302 of 1.8 MHz, these values forming a global spectrum 400 of the RSSI indicator on the UMTS band (such as is shown in FIG. 5). This first step 701 forms a first phase of obtaining the global spectrum 400.

Within the framework of a second phase (comprising the steps 702 to 705 described hereinafter), the mobile apparatus 100 implements a spectral analysis of the global spectrum 400 of the RSSI indicator on the UMTS bandwidth. This analysis implementing thresholds and differences is based on a recognition of the spectral form of at least one carrier (cf. FIG. 2) on the global spectrum 400 of the RSSI indicator obtained in the aforementioned phase 1 and on the obtaining of the central frequency Fc of the carrier or carriers recognised as such.

In a second step 702, the mobile apparatus 100 implements a detection of the values of the RSSI indicator of the global spectrum 400 which are greater than a first threshold 203 (which is for example equal to −95 dBm). This first threshold 203 delimits the frequencies f1′ and f2′ on the spectrum of the carrier 200 in FIG. 2 which are slightly further away on either side of the central frequency Fc than the frequencies f1 and f2 (delimited by the one second threshold Im-3 dB) corresponding to the width at mid-height.

In a third step 703, by scanning the spectrum of the value of the RSSI indicator from the beginning of the UMTS band, for each current value of the RSSI indicator which is greater than the threshold, the mobile apparatus 100 verifies if the first next value and the second next value of the RSSI indicator in the global spectrum 400 are also greater than the threshold.

In the case where at least the first next value is also greater than the threshold, then, this means that the central frequency Fc of a carrier of a downlink of the UMTS channel in FDD mode (included in a gauge on the global spectrum 400 of the RSSI indicator) is between the frequency corresponding to the current value and the frequency corresponding to the second next value of the RSSI indicator. As such, in this case, the mobile apparatus 100 has thus detected a current carrier.

Then, in a fourth step 704, in the case where several carriers are detected in the step 703, the mobile apparatus 100 carries out a classification of the carriers in decreasing order of the average value of the RSSI indicator (the average value of the RSSI indicator of a carrier being obtained by taking an average of the current and next values of the RSSI indicator which have made it possible to detect this carrier in the step 703) of the carriers detected in order to favour the carriers with higher power (and therefore the central frequencies of high-power carriers).

In a fifth step 705, for at least one of the carriers detected in the third step 703, and preferentially for that of the highest power placed at the top of the classification of the fourth step 704 (called hereinafter preponderant carrier), the mobile apparatus 100 executes a precise search 500 (shown in FIG. 6) of the central frequency Fc of the carrier.

For this, in the case where only the current value and the first next value of the RSSI indicator (which are the values which made it possible to detect the preponderant carrier in the step 703) are greater than the first threshold (i.e. the second next value is lower than the first threshold), then the mobile apparatus 100 calculates the difference (in dB) between the current value and the first next value of the RSSI indicator.

If this difference (or deviation) is substantially equal to 0 dB, then this means that the central frequency of the preponderant carrier is located substantially in the middle of the segment delimited by the frequency corresponding to the current value and the frequency corresponding to the aforementioned first next value of the RSSI indicator.

If this difference (or deviation) is substantially greater than 0 dB, then this means that the central frequency of the preponderant carrier is on the segment delimited by the frequency corresponding to the current value and the frequency corresponding to the aforementioned first next value of the RSSI indicator but closer to the frequency corresponding to the current value than the frequency corresponding to the first next value.

If this difference (or deviation) is substantially less than 0 dB, then this means that the central frequency of the preponderant carrier is on the segment delimited by the frequency corresponding to the current value and the frequency corresponding to the aforementioned first next value of the RSSI indicator but closer to the frequency corresponding to the first next value than the frequency corresponding to the current value.

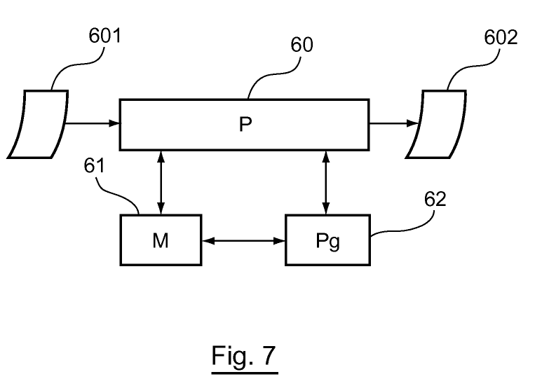

FIG. 7 shows a simplified diagram of a mobile apparatus in accordance with a particular embodiment of the invention, which comprises a specification M 61 (for example a RAM memory), a processing unit P 60, provided for example with a microprocessor, and controlled by the computer programme (or application) Pg 62 implementing certain steps in the method described in FIG. 3.

At initialisation, the computer programme code instructions 62 are for example loaded into the RAM memory 61 before being executed by the microprocessor of the processing unit 60. The processing unit 60 received as input the signals, coming from the UMTS communication channel in FDD mode, available in the cell wherein the mobile apparatus is located. The microprocessor of the processing unit 60. The processing unit 60 delivers as output the value of the frequency or frequencies that carry downlink(s) obtained.

At least one embodiment of the disclosure provides a technique for detecting the central frequency of at least one carrier of a wide-band downlink of a communication channel by a mobile apparatus which is faster than the conventional techniques.

At least one embodiment provides such a technique thanks to which the mobile apparatus can rapidly detect the presence of such a channel and can as such rapidly access this channel.

At least one embodiment provides such a technique which is simple to implement and this for a low cost.

Although the present disclosure has been described with reference to one or more examples, workers skilled in the art will recognize that changes may be made in form and detail without departing from the scope of the disclosure and/or the appended claims.

1. A method for detecting by a mobile apparatus a central frequency of at least one carrier of a wide-band downlink of a communication channel associated to a frequency band, the at least one carrier belonging to said frequency band, the method comprising:
a first phase of measuring the value of an indicator representative of a power received by the mobile apparatus for a plurality of frequencies evenly spaced in the frequency band to obtain a spectrum of values of the indicator on the frequency band, and
a second phase of analysing the spectrum of the indicator comprising:
a step of recognising a form of the at least one carrier in said spectrum of the indicator, said step of recognising the form of a current carrier comprising a step of identifying at least two consecutive values of the spectrum of the indicator which are greater than a predetermined threshold, said values being representative of the current carrier; and
a step of detecting the central frequency of the at least one carrier.

2. The method according to claim 1, wherein the step of detecting the central frequency of said current carrier comprises the following steps:
determining a limited frequency window from among a plurality of evenly spaced frequencies, by comparing said at least two consecutive values of the spectrum of the indicator which are greater than a predetermined threshold, said limited window comprising said central frequency;
obtaining said central frequency by scanning said limited window.

3. The method according to claim 1, at least two central frequencies of at least two carriers being recognised in the step of recognising, wherein the step of recognising further comprises a step of classifying carriers in decreasing order of the value of the indicator.

4. The method according to claim 1, wherein the communication channel is a Universal Mobile Communication System (UMTS) communication channel in Frequency Division Duplex (FDD) mode, each carrier of a wide-band downlink being a carrier of a UMTS downlink in FDD mode.

5. The method according to claim 4, wherein said frequency series is evenly spaced by a step of 1.8 MHz.

6. The method according to claim 4, wherein said indicator comprises a Received Signal Strength Indicator (RSSI) indicator.

7. A computer software product recorded on a medium that can be read by a computer and executed by a processor, wherein the product comprises programme code instructions for execution of a method of detecting by a mobile apparatus a central frequency of at least one carrier of a wide-band downlink of a communication channel associated to a frequency band, the at least one carrier belonging to said frequency band, when said programme is executed on a computer, wherein the method comprises:
a first phase of measuring the value of an indicator representative of a power received by the mobile apparatus for a plurality of frequencies evenly spaced in the frequency band to obtain a spectrum of values of the indicator on the frequency band, and
a second phase of analysing the spectrum of the indicator comprising:
a step of recognising a form of the at least one carrier in said spectrum of the indicator, said step of recognising the form of a current carrier comprising a step of identifying at least two consecutive values of the spectrum of the indicator which are greater than a predetermined threshold, said values being representative of the current carrier; and
a step of detecting the central frequency of the at least one carrier.

8. A storage device that can be read by a computer, storing a set of instructions that can be executed by said computer in order to implement a method of detecting by a mobile apparatus a central frequency of at least one carrier of a wide-band downlink of a communication channel associated to a frequency band, the at least one carrier belonging to said frequency band, wherein the method comprises:
a first phase of measuring the value of an indicator representative of a power received by the mobile apparatus for a plurality of frequencies evenly spaced in the frequency band to obtain a spectrum of values of the indicator on the frequency band, and
a second phase of analysing the spectrum of the indicator comprising:
a step of recognising a form of the at least one carrier in said spectrum of the indicator, said step of recognising the form of a current carrier comprising a step of identifying at least two consecutive values of the spectrum of the indicator which are greater than a predetermined threshold, said values being representative of the current carrier; and
a step of detecting the central frequency of the at least one carrier.

9. A mobile apparatus comprising:
means for detecting a central frequency of at least one carrier of a wide-band downlink of a communication channel associated to a frequency band, the at least one carrier belonging to said frequency band, the means for detecting comprising:
means for measuring the value of an indicator representative of a power received by the mobile apparatus for a plurality of frequencies evenly spaced in the frequency band to obtain a spectrum of values of the indicator on the frequency band, and
means for analysing the spectrum of the indicator comprising:
means for recognising a form of the at least one carrier in said spectrum of the indicator, said means for recognising the form of a current carrier comprising means for identifying at least two consecutive values of the spectrum of the indicator which are greater than a predetermined threshold, said values being representative of the current carrier; and
means for detecting the central frequency of said at least one carrier.
